(19) United States
(12) Patent Application Publication
(10) Pub. No.: US 2026/0278420 A1
(43) Pub. Date: Sep. 17, 2026

(54) MACHINE LEARNING SYSTEM, SERVER DEVICE, CLIENT DEVICE, MACHINE LEARNING METHOD, AND COMPUTER READABLE MEDIUM

(71) Applicant: Mitsubishi Electric Corporation, Tokyo (JP)

(72) Inventor: Kento OONISHI, Tokyo (JP)

(73) Assignee: Mitsubishi Electric Corporation, Tokyo (JP)

(21) Appl. No.: 19/683,477

(22) Filed: May 20, 2026

Related U.S. Application Data
(63) Continuation of application No. PCT/JP2024/000208, filed on Jan. 9, 2024.

(51) Int. Cl. G06N 5/04

(52) U.S. Cl. CPC G06N 5/04

(57) ABSTRACT

A machine learning system (500) includes a client device (200) that has its own unique learning data and a server device (100) that has training data. Each of the client device (200) and the server device (100) has an AI model. Further, the machine learning system (500) proceeds with learning while keeping the learning data of the client device (200) and the training data of the server device (100) private to each other. The server device (100) includes a fraudulent client detection unit (2530) to estimate a fraudulent client device that performs an attack to disrupts the learning of the AI model in the server device (100).

### CROSS REFERENCE TO RELATED APPLICATIONS

This application is a Continuation of PCT International Application No. PCT/JP2024/000208 filed on Jan. 9, 2024, all of which is hereby expressly incorporated by reference into the present application.

### TECHNICAL FIELD

The present disclosure relates to a machine learning system, a server device, a client device, a machine learning method, and a machine learning program.

### BACKGROUND ART

Federated learning is a technology that integrates learned models that have been individually learned by a plurality of clients to generate a large-scale AI model. The learned model is hereinafter referred to as an “AI model”. AI is an abbreviation for Artificial Intelligence. In federated learning, each client has its own unique learning data, and a characteristic of pieces of unique learning data is that they remain private to each other. Federated learning includes horizontal federated learning and vertical federated learning.

In federated learning, there is a threat of learning disruption attacks on a server using fraudulent data that does not align with standard learning methods. The threat of learning disruption attacks on the server is, for example, a malicious and fraudulent client. Especially, in many cases of horizontal federated learning, a decline in the reliability of the AI model to be generated on the server occurs when learning is performed with biased data on each client.

In Patent Literature 1, a technology is disclosed in which a server averages models uploaded from each client and excludes a client whose model significantly deviates from the averaged model, in horizontal federated learning. This technology discloses how to prevent the decline in the reliability of the AI model.

In Non-Patent Literature 1, a defense method is disclosed in which encryption is used to defend against attacks designed to cause other specific inference results to misrecognize backdoor images that include specific patterns, in vertical federated learning.

### CITATION LIST

### Patent Literature

Patent Literature 1: JP 6231944 B2

### Non-Patent Literature

Non-Patent Literature 1: Zou, Tianyuan, et al. “Defending batch-level label inference and replacement attacks in vertical federated learning.” IEEE Transactions on Big Data, 2022.

### SUMMARY OF INVENTION

### Technical Problem

The defense technology against the threat of learning disruption attacks on the server described in Patent Literature 1 can only be applied to horizontal federated learning in which there is similarity in the information sent from clients to the server. Therefore, there is a problem that this technology cannot be applied to vertical federated learning.

Further, the defense method described in Non-Patent Literature 1 is a defense method against attack techniques that provide input with a negative impact on the server in vertical federated learning. This defense method is only for defense that renders the estimation of training data held by the server impossible through encryption. Therefore, there is a problem in that it is impossible to prevent attacks on input data.

The present disclosure aims to prevent learning disruption attacks on the server, in a machine learning system that performs federated learning. Especially, the present disclosure aims to enable the detection of malicious and fraudulent clients even in a situation where there is no similarity in the information sent from each client to the server, as in vertical federated learning.

### Solution to Problem

A machine learning system according to the present disclosure includes a client device that has its own unique learning data and a server device that has training data, each of the client device and the server device possessing an Artificial Intelligence (AI) model, and that proceeds with learning while keeping the learning data of the client device and the training data of the server device private to each other, wherein the server device includes a fraudulent client detection unit to estimate a fraudulent client device that performs an attack that disrupts the learning of the AI model in the server device.

### Advantageous Effects of Invention

In the machine learning system according to the present disclosure, in the machine learning system that performs federated learning, the fraudulent client detection unit in the server device estimates a fraudulent client device that performs an attack that disrupts learning of the AI model in the server device. Therefore, according to the machine learning system according to the present disclosure, even in a situation where there is no similarity in the information sent from each client device to the server device, the machine learning system according to the present disclosure, there is an effect of being able to detect a malicious and fraudulent client device.

### BRIEF DESCRIPTION OF DRAWINGS

FIG. 1 is a diagram illustrating an example of an overall configuration of a machine learning system according to Embodiment 1.

FIG. 2 is a diagram illustrating an example of a configuration of a server device according to Embodiment 1.

FIG. 3 is a diagram illustrating an example of a functional configuration of the server device according to Embodiment 1.

FIG. 4 is a flowchart illustrating operation of the server device in the machine learning system according to Embodiment 1.

FIG. 5 is a flowchart illustrating the operation of the server device in the machine learning system according to Embodiment 1.

FIG. 6 is a diagram illustrating an example of the configuration of the server device according to a modification example of Embodiment 1.

FIG. 7 is a flowchart illustrating the operation of the server device in the machine learning system according to Embodiment 2.

FIG. 8 is a diagram illustrating an example of a functional configuration of a client device according to Embodiment 3.

FIG. 9 is a flowchart illustrating operation of the client device in the machine learning system according to Embodiment 3.

### DESCRIPTION OF EMBODIMENTS

Embodiments of the present disclosure will be described hereinafter with reference to the drawings. In each drawing, the same or corresponding parts are denoted by the same reference sign. In the description of the embodiments, details of the same or corresponding parts will be suitably omitted or simplified. Arrows in the drawings mainly indicate flows of data or flows of processing.

### Embodiment 1

In the present embodiment, a method of preventing learning disruption attacks on vertical federated learning will be described. In horizontal federated learning, a server integrates AI models that have learned with data of different learning targets and the same attributes for each client. Especially, in horizontal federated learning, all client have the same structures for the AI models. In most methods of horizontal federated learning, a generated AI model is ultimately distributed to all clients and the server.

On the other hand, in vertical federated learning, each client learns an AI model with data of different attributes of the same target. To satisfy this requirement, in vertical federated learning, each client and the server has its own unique AI model and learning is proceeded so that, when all AI models are integrated, they form a single AI model. Vertical federated learning has a feature that all clients and the server have different structures of AI models, each client is unaware of the AI models possessed by the other clients, and only the server holds an output result.

### ***Description of Configuration***

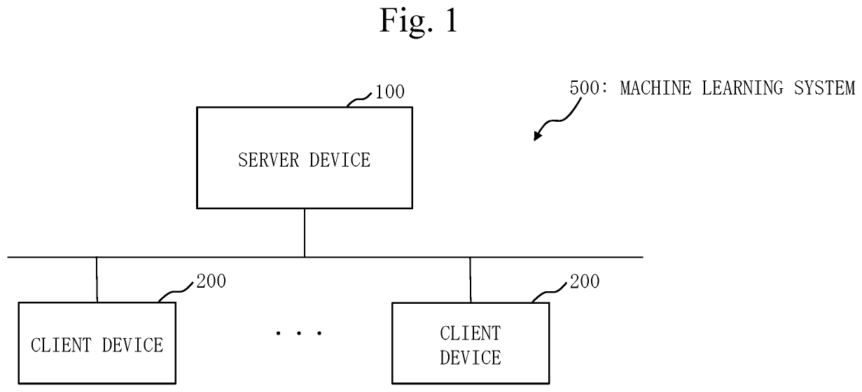

FIG. 1 is a diagram illustrating an example of an overall configuration of a machine learning system 500 according to the present embodiment.

The machine learning system 500 includes a server device 100 and a client device 200 that communicates with the server device 100. A plurality of client devices 200 are included.

In the machine learning system 500 of the present embodiment, each of the server device 100 and the client devices 200 possesses its own unique AI model. The server device 100 has training data. The client device 200 has its own unique learning data. Further, in the machine learning system 500, learning is proceeded with the learning data of the client devices 200 and the training data of the server device 100 which remain private to each other.

In the following description, the server device may simply be referred to as a server. Further, the client device may simply be referred to as a client.

The machine learning system 500 according to the present embodiment can be applied to sensitive determination such as a health screening, as a specific example. In FIG. 1, the server device 100 is a computer such as a host computer that is installed in a large hospital, for example. The client device 200 is a computer that is installed in the client such as a contracted health screening facility, or an institution or a store that deals with health information.

The client device 200 in the contracted health screening facility, or the institution or the store that deals with health information collects individual health information. Then, the client device 200 processes the collected information with each of the AI models before sending the collected information to the server device 100 installed in the large hospital. Then, the server device 100 installed in the large hospital performs health screening for a corresponding individual and performs determination of illness.

An attack method in which a malicious client manipulates input data during learning to attempt to alter the AI model that builds the health screening system, that is, a learning disruption attack, is considered to be against such a health screening system, for example. The malicious client may aim to increase visitors to each of its own health screening facility, institution, and store, or may also aim to collapse the entire health screening system, for example. In such a case, in the present embodiment, it is possible to specify or estimate the malicious client that transmits the manipulated input data, and protect the AI model on the server from the learning disruption attack.

The present embodiment can be applied to determination of personal credit information used for a loan or the like, as a specific example. A server processing unit 2000 to be described below is, for example, a computer such as a host computer installed in a financial institution where an individual has applied for a loan, for example. The client device 200 is, for example, a computer installed in another financial institution or a store where an individual purchases goods. In the present embodiment, each of the financial institution and the store collects personal financial information. Subsequently, this information is processed by each of the AI models before being tr to the server processing unit 2000 installed in the financial institution where the individual has applied for a loan. Subsequently, the server processing unit 2000 installed in the financial institution where the individual has applied for a loan performs determination of a financial situation of the corresponding individual and performs determination of a loan approval.

An attack method in which a malicious client performs obstruction of business operations at a financial institution by manipulating input data during learning to alter the AI model is considered to be against such a credit information determination system, for example. The malicious client aims to modify a determination result unreasonably and force the financial institution that has a host computer or a server device to perform an unreasonable transaction or a loan. At this time, in the present embodiment, it is possible to specify or estimate the malicious client that transmits the manipulated input data and protect the AI model on the server from an attack such as the above.

Further, the present embodiment can also be applied to the machine learning system that is applied to FA equipment. FA is an abbreviation for Factory Automation. The server processing unit 2000 to be described below is, for example, a computer such as a host computer installed in a mother factory. The client device is, for example, a computer installed in a contracted manufacturing factory. In the preset embodiment, when a single product is manufactured, each contracted manufacturing factory is in charge of a part of the process. However, for technology protection purposes, the contracted manufacturing factory keeps its process, the equipment used in the process, and the equipment data in the process confidential from the mother factory or other contracted manufacturing factories. Here, it is considered to integrate measurement information in the FA equipment of each factory for performing automation and refinement of inspection. In the present embodiment, each contracted manufacturing factory transmits data obtained by each equipment to the host computer or the server device installed in the mother factory after manipulating the data by the AI model. Subsequently, the host computer or the server device installed in the mother factory performs the inspection. An attack method is considered in which a malicious client manipulates input data during learning to alter the AI model is considered to be against this inspection system, for example. The malicious client is considered to have a purpose such as hiding its fraud despite not producing a part that satisfies specifications. At this time, in the present embodiment, it is possible to specify or estimate the malicious client that transmits the manipulated input data and protect the AI model on the server from an attack such as the above.

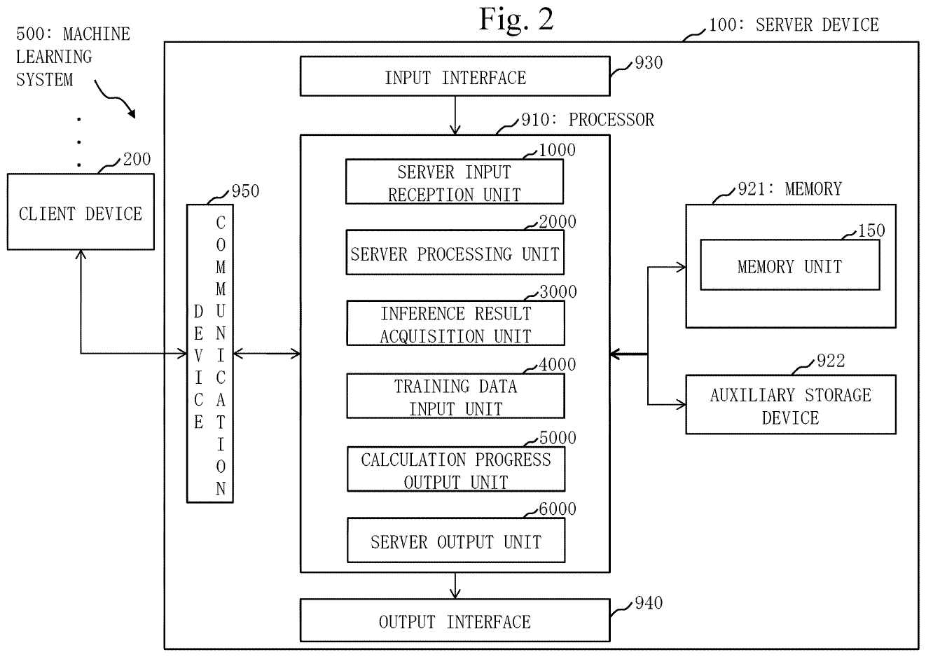

FIG. 2 is a diagram illustrating an example of a configuration of the server device 100 according to the present embodiment.

In the following, each device of the server device 100 and client device 200 may be referred to as each device of the machine learning system 500.

Further, in the following, hardware of the server device 100 will be described as an example. The same description of the server device 100 can be applied to hardware of the client device 200.

The server device 100 is a computer. The server device 100 includes a processor 910 and also includes other pieces of hardware such as a memory 921, an auxiliary storage device 922, an input interface 930, an output interface 940, and a communication device 950. The processor 910 is connected to the other pieces of hardware via signal lines and controls the other pieces of hardware.

The server device 100 includes, as functional elements, a server input reception unit 1000, the server processing unit 2000, an inference result acquisition unit 3000, a training data input unit 4000, a calculation progress output unit 5000, a server output unit 6000, and a memory unit 150.

Functions of the server input reception unit 1000, the server processing unit 2000, the inference result acquisition unit 3000, the training data input unit 4000, the calculation progress output unit 5000, and the server output unit 6000 are implemented by software. The memory unit 150 is provided in the memory 921. The memory unit 150 may be provided in the auxiliary storage device 922, or may be distributed and provided in both the memory 921 and the auxiliary storage device 922.

The processor 910 is a device that executes a machine learning program. The machine learning program is a program that implements a function of each device in the machine learning system 500.

The processor 910 is an IC that performs arithmetic processing. Specific examples of the processor 910 are a CPU, a DSP, and a GPU. IC is an abbreviation for Integrated Circuit. CPU is an abbreviation for Central Processing Unit. DSP is an abbreviation for Digital Signal Processor. GPU is an abbreviation for Graphics Processing Unit.

The memory 921 is a storage device to temporarily store data. Specific examples of the memory 921 are an SRAM and a DRAM. SRAM is abbreviation for Static Random Access Memory. DRAM is abbreviation for Dynamic Random Access Memory.

The auxiliary storage device 922 is a storage device to save data. A specific example of the auxiliary storage device 922 is an HDD. Further, the auxiliary storage device 922 may be a portable storage medium such as an SD (registered trademark) memory card, CF, a NAND flash, a flexible disk, an optical disc, a compact disc, a Blu-ray (registered trademark) disc, or a DVD. HDD is an abbreviation for Hard Disk Drive. SD (registered trademark) is abbreviation for Secure Digital. CF is abbreviation for CompactFlash (registered trademark). DVD is abbreviation for Digital Versatile Disk.

The input interface 930 is a port to which an input device such as a mouse, a keyboard, or a touch panel is connected. Specifically, the input interface 930 is a USB terminal. The input interface 930 may also be a port connected to a LAN. USB is short for Universal Serial Bus. LAN is abbreviation for Local Area Network. Although only one input interface 930 is illustrated in FIG. 2, there may be a plurality of input interfaces 930.

The output interface 940 is a port to which a cable of an output device such as a display is connected. Specifically, the output interface 940 is a USB terminal or an HDMI (registered trademark) terminal. Specifically, the display is an LCD. The output interface 940 is also referred to as a display interface. HDMI (registered trademark) is an abbreviation for High Definition Multimedia Interface. LCD is abbreviation for Liquid Crystal Display. Although only one output interface 940 is illustrated in FIG. 2, there may be a plurality of output interfaces 940.

The communication device 950 includes a receiver and a transmitter. The communication device 950 is connected to a communication network such as a LAN, the Internet, a telephone line, or Wi-Fi (registered trademark). Specifically, the communication device 950 is a communication chip or an NIC. NIC is an abbreviation for Network Interface Card.

The machine learning program is executed in each device of the machine learning system 500. The machine learning program is loaded into the processor 910 and executed by the processor 910. The memory 921 stores not only the machine learning program but also an OS. The OS is an abbreviation for Operating System. While executing the OS, the processor 910 executes the machine learning program. The machine learning program and the OS may be stored in the auxiliary storage device 922. The machine learning program and the OS stored in the auxiliary storage device 922 are loaded into the memory 921 and executed by the processor 910. The machine learning program may be partially or entirely embedded in the OS.

Each device of the machine learning system 500 may include a plurality of processors as an alternative to the processor 910. These processors share execution of the machine learning program. Each processor is a device that executes the machine learning program in the same manner as the processor 910.

Data, information, signal values, and variable values used, processed, or outputted by the machine learning program are stored in the memory 921, the auxiliary storage device 922, or a register or a cache memory in the processor 910.

“Unit” of each unit of each device of the machine learning system 500 may be interpreted as “circuit”, “step”, “procedure”, “process”, or “circuitry”. The machine learning program causes a computer to execute processes where the “unit” of each unit of each device of the machine learning system 500 is interpreted as “process”. The “process” in the processes where the “unit” of each unit of each device of the machine learning system 500 is interpreted as “process” may be interpreted as “program”, “program product”, “computer readable storage medium storing a program”, or “computer readable recording medium recording a program”. Further, a machine learning method is a method performed by each device of machine learning system 500 executing the machine learning program.

The machine learning program may be stored and provided in a computer readable recording medium. Alternatively, the machine learning program may be provided as a program product.

### ***Description of Functions***

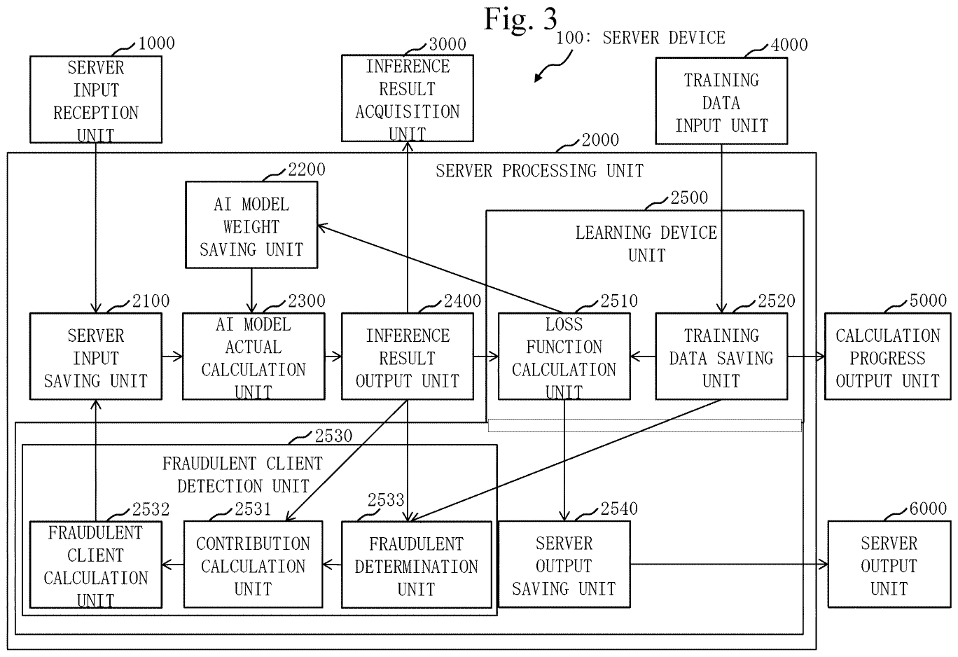

FIG. 3 is a diagram illustrating an example of a functional configuration of the server device 100 according to the present embodiment.

The example of the functional configuration of the server device 100 according to the present embodiment will be described using FIG. 3.

The server input reception unit 1000 receives input from each client device 200 and outputs the input directly to a server input saving unit 2100.

The server processing unit 2000 receives from the server input reception unit 1000, the input from each client device as client input. Further, the server processing unit 2000 receives the training data as input from the training data input unit 4000. Then, the server processing unit 2000 outputs an inference result for each client input to the inference result acquisition unit 3000. Further, the server processing unit 2000 outputs a progress status of a calculation to the calculation progress output unit 5000. Further, the server processing unit 2000 outputs to the server output unit 6000, a transmission value to each client device.

In the following, detailed functions within the server processing unit 2000 will be described.

The server processing unit 2000 includes the server input saving unit 2100, an AI model weight saving unit 2200, an AI model actual calculation unit 2300, an inference result output unit 2400, and a learning device unit 2500.

The server input saving unit 2100 receives and saves each client input outputted from the server input reception unit 1000. Each saved client input is outputted to the AI model actual calculation unit 2300. At this time, output to the AI model actual calculation unit 2300 may be processed by input from a fraudulent client calculation unit 2532.

The AI model weight saving unit 2200 receives input from a loss function calculation unit 2510, and updates and saves the weight of the AI model. The saved weight of the AI model is outputted to the AI model actual calculation unit 2300.

The AI model actual calculation unit 2300 performs inference using each client input inputted from the server input saving unit 2100 and the weight of the AI model inputted from the AI model weight saving unit 2200. The inference result is outputted to the inference result output unit 2400.

The inference result output unit 2400 acquires the inference result calculated at the AI model actual calculation unit 2300 as input, and outputs the acquired inference result directly to the loss function calculation unit 2510, a contribution calculation unit 2531 for each input, and the inference result acquisition unit 3000.

The learning device unit 2500 receives the inference result received from the inference result output unit 2400 and the training data received from the training data input unit 4000 as input, calculates an update value for the AI model weight, and outputs the update value to the AI model weight saving unit 2200.

Further, the learning device unit 2500 outputs a progress status of a calculation to the calculation progress output unit 5000, and outputs to the server output unit 6000, a transmission value to each client.

The learning device unit 2500 includes the loss function calculation unit 2510, a training data saving unit 2520, a fraudulent client detection unit 2530, and a server output saving unit 2540.

The loss function calculation unit 2510 inputs the inference result received from the inference result output unit 2400 and the training data saved in the training data saving unit 2520, and calculates a loss function. The loss function calculation unit 2510 calculates the update value of the AI model weight using the loss function, and outputs the update value to the AI model weight saving unit 2200. Further, the loss function calculation unit 2510 outputs to the server output saving unit 2540, a value to be used for update of the AI model in each client device.

The training data saving unit 2520 saves the training data received from the training data input unit 4000 and outputs the training data to the loss function calculation unit 2510. Further, the training data saving unit 2520 outputs to the calculation progress output unit 5000, calculation progress information corresponding to its output.

The fraudulent client detection unit 2530 estimates a fraudulent client device that performs an attack that disrupts learning of the AI model in the server device 100.

The fraudulent client detection unit 2530 receives the inference result from the inference result output unit 2400, and outputs the inference result to the server input saving unit 2100 by specifying or estimating the fraudulent client device.

The fraudulent client detection unit 2530 estimates the fraudulent client device by comparing the training data with the inference result acquired from the input of client device 200. When comparing the training data with the inference result, the fraudulent client detection unit 2530 calculates contribution to the inference result on the client device 200, and estimates the fraudulent client device using the contribution to the inference result.

Specifically, the fraudulent client detection unit 2530 calculates similarity between the training data and the inference result, and determines whether or not there is inconsistency between the training data and the inference result based on the similarity. When there is the inconsistency between the training data and the inference result, the fraudulent client detection unit 2530 treats the inference result as an incorrect inference result, and estimates a client device whose contribution to the inference result is high as the fraudulent client device. The incorrect inference result may be referred to as a fake label.

A more specific description will be given below.

The fraudulent client detection unit 2530 includes the contribution calculation unit 2531 for each input, the fraudulent client calculation unit 2532, and a fraudulent determination unit 2533.

The contribution calculation unit 2531 for each input receives the inference result of the inference result output unit 2400 as input, estimates the extent to which each client device influences the inference result, and outputs its calculation result to the fraudulent client calculation unit 2532.

The fraudulent client calculation unit 2532 receives input from each contribution calculation unit 2531 for each input, specifies or estimates a client device that is suspected of fraud, and outputs its inference result to the server input saving unit 2100.

The fraudulent determination unit 2533 calculates the similarity between the training data and the inference result, and determines whether or not there is inconsistency between the training data and the inference result based on the similarity.

The server output saving unit 2540 saves an output value to the client device inputted from the loss function calculation unit 2510, and outputs the output value to the server output unit 6000. The output value to the client device is a value to be used for update of the AI model in the client device.

The inference result acquisition unit 3000 inputs the inference result from the inference result output unit 2400, and outputs the inference result to either a person who manages the server device 100 or an external device.

The training data input unit 4000 inputs the training data to be used for learning from the person who manages the server device 100 or the external device, and outputs the training data to the server processing unit 2000.

The calculation progress output unit 5000 inputs output information of the training data saving unit 2520, and outputs the inference result to either the person who manages the server device 100 or the external device.

The server output unit 6000 inputs a server output value from the server output saving unit 2540, that is, the output value to each client device, and outputs the value to each client device during learning.

### ***Description of Operation***

Next, operation of the machine learning system 500 according to the present embodiment will be described. A procedure for the operation of the machine learning system 500 is equivalent to the machine learning method. Further, a program that implements the operation of the machine learning system 500 is equivalent to the machine learning program.

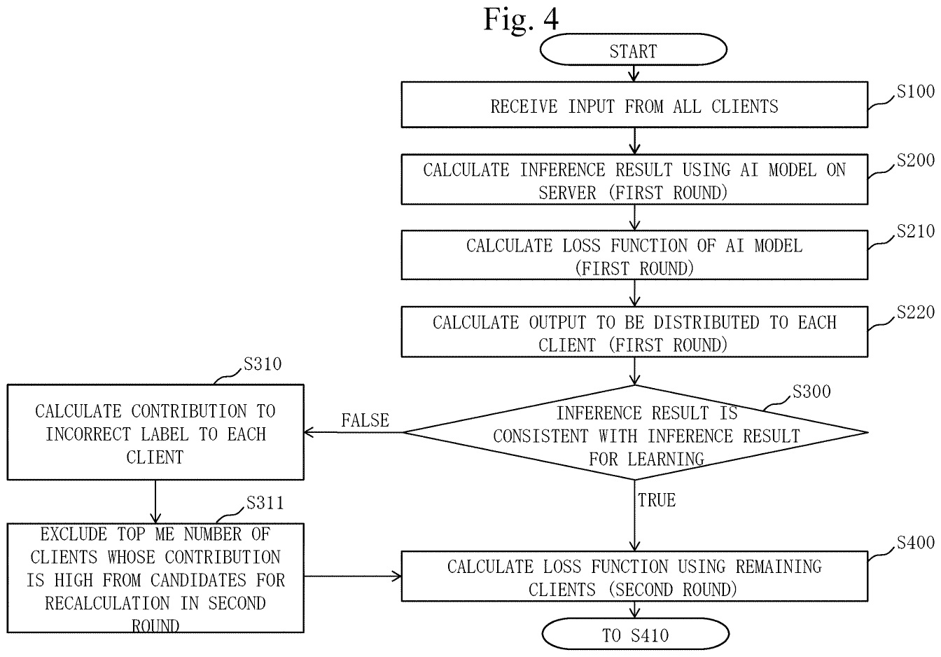

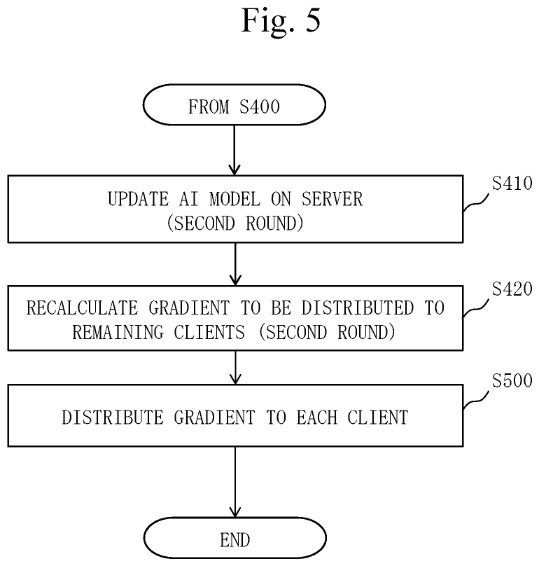

FIGS. 4 and 5 are flowcharts illustrating operation of the server device 100 in the machine learning system 500 according to the present embodiment.

Machine learning including federated learning consists of two stages: the learning stage for updating the AI model; and the evaluation stage for using the AI model that has completed learning. The present embodiment mainly handles the learning stage, and the calculation of the update value of the AI model is performed twice in steps S220 and S420.

In the present embodiment, each of these updates is referred to as the first round and the second round. The first round consists of steps S200, S210, and S220. Further, the second round consists of steps S400, S410, and S420.

In the following, the operation of the machine learning system 500 according to the present embodiment will be described using the flowcharts of FIGS. 4 and 5.

In FIG. 4, the process from steps S100 to S400 is described. In FIG. 5, the process from steps S410 to S500 is described.

The flowcharts during learning illustrated in FIGS. 4 and 5 indicate one iteration of vertical federated learning. Input of a parameter me is required. A value of this me is a parameter that can be set for each iteration depending on the progress degree of learning or the presence degree of an attacker.

This parameter me can be inputted at any timing as long as it is inputted before step S311 in which the parameter me is used within one iteration. Especially, by deciding the parameter me after calculating the contribution to an incorrect label in step S310, the parameter me can be set as a threshold value for the contribution. Further, although the flowcharts illustrated in FIGS. 4 and 5 indicate one iteration of vertical federated learning, it is also possible to perform batch processing to process a plurality of iterations at once.

First, the flow of operation of the learning stage for updating the AI model will be described.

### <Server Input Reception Process: Step S100>

First, in step S100, the server input reception unit 1000 receives input from all clients. An input zi (i=1, 2, . . . , k) from the clients which is received by the server input reception unit 1000 is inputted to the server processing unit 2000. Here, k is the number of clients that participate in the vertical federated learning. The input from the clients to the server processing unit 2000 is saved in the server input saving unit 2100.

### <Calculation (First Round) of Update Value of AI Model: Steps S200 to S220>

### <<AI Model Actual Calculation Process: Step S200>>

Next, a calculation (first round) of the update value of the AI model is performed.

First, in step S200, the AI model actual calculation unit 2300 performs inference on the inference result for integrated input of the client input using the AI model on the server. The AI model actual calculation unit 2300 performs a calculation by calling out a weight w of the AI model from the AI model weight saving unit 2200 for an input Z=(z1, z2, . . . , zk) saved in the server input saving unit 2100, and outputs an inference result p=(p1, p2, . . . , pN) to the inference result output unit 2400. Here, N is the number of classes of classification destination in the AI model, and each pi represents probability that the output result belongs to a class i.

### <<Loss Function Calculation Process: Steps S210 and S220>

Next, in step S210, the loss function calculation unit 2510 calculates a loss function L to be used for update of the AI model. This calculation uses input from the inference result output unit 2400 and the training data saving unit 2520. Specifically, probability distribution p of N class=(p1, p2, . . . , pN) is outputted from the inference result output unit 2400. Further, an N-dimensional vector t=(t1, t2, . . . , tN) where a correct label ti is 1 and all others are 0, is used in input from the training data saving unit 2520. At this time, a sum of squared errors Σ(ti−pi)\hat{ }2 or a cross entropy error −Σtilog(pi) is used as the loss function. The training data saving unit 2520 stores values inputted via the training data input unit 4000.

Further, in step S220, the loss function calculation unit 2510 performs backpropagation of errors on the calculated loss function L, calculates an output value ∂L/∂zi(i=1, 2, . . . , k) to be used for the update value of the AI model on a client side, and stores the output value in the server output saving unit 2540.

### <Inference Result Consistency Determination Process: Step S300>

Further, in step S300, the fraudulent determination unit 2533 of the fraudulent client detection unit 2530 checks whether or not the inference result stored in the inference result output unit 2400 is consistent with the inference result stored in the training data saving unit 2520. The fraudulent determination unit 2533 calculates the similarity between the training data and the inference result, and determines whether or not there is inconsistency between the training data and the inference result based on the similarity, for example.

When the inference results are not consistent with each other, that is, when there is inconsistency between the training data and the inference result, it is suspected that there may be a fraudulent client, and the process proceeds to step S310.

When the inference results are consistent with each other, that is, when there is no inconsistency between the training data and the inference result, it is determined that there is no fraudulent client, and the process proceeds to step S400.

Further, “consistent” mentioned here can be variously defined according to a characteristic of data being used.

As an example of the definition of “consistent”, “consistent” can be defined as whether or not the maximum likelihood inference result of the inference result output unit 2400 is consistent with the maximum likelihood inference result of the inference result corresponding to the training data saving unit 2520. Specifically, output of a function that performs different output when the maximum likelihood estimation results are consistent with each other and when the maximum likelihood estimation results are not consistent with each other, is referred to as “similarity”. When the results are consistent with each other, 0 is outputted, and when the results are not consistent with each other, the output of the function that outputs 1 is the “similarity”, for example. At this time, when the “similarity” is 0, the fraudulent determination unit 2533 determines that there is no inconsistency between the training data and the inference result, and when the “similarity” is 1, there is inconsistency between the training data and the inference result.

Further, “consistent” can also be defined not only by the maximum likelihood estimation result, but also by introducing a distance space to the training data and the inference result, then setting a threshold value for its distance. Specifically, the distance calculated in the distance space is the “similarity”. In this case, when the “similarity” is less than a certain threshold value, the fraudulent determination unit 2533 determines that there is no inconsistency between the training data and the inference results. Further, when the “similarity” is greater than the certain threshold value, the fraudulent determination unit 2533 determines that there is inconsistency between the training data and the inference results.

### <Contribution Calculation Process (Incorrect Label): Step S310>

In step S310, the contribution calculation unit 2531 for each input calculates the contribution of each client for the maximum likelihood inference result of the inference result output unit 2400. Here, the maximum likelihood inference result of the inference result output unit 2400 is what is denoted as incorrect label in the flowchart in FIG. 4. In step S310, the contribution is calculated by treating the input of all clients as the input of the model on the server and using Grad-Cam. In this contribution calculation, it is possible to superimpose the contribution corresponding not only to a single incorrect label but also to a plurality of incorrect labels. There is a method in which the contribution can be calculated for each of the plurality of incorrect labels each of which has a high likelihood, and a weighted average can be performed on the contribution using the likelihood as the weight, for example. In addition to this weighted average, various methods that incorporate the likelihood as the weight can be applied.

### <Fraudulent Client Calculation Process (Incorrect Label): Step S311>

In step S311, the fraudulent client calculation unit 2532 detects the top me number of clients that indicate high contributions to the incorrect label, as fraudulent clients. Then, the fraudulent client calculation unit 2532 excludes the detected fraudulent clients from candidates for a recalculation of the update value of the AI model in the second round to be described below. Then, the process proceeds to step S400.

### <Calculation (Second Round) of Update Value of AI Model: Steps S400 to S420>

In step S400, the loss function calculation unit 2510 recalculates a loss function L′ based on the input values of the clients that have not been excluded in step S311. In this calculation, with respect to the inputs saved in the server input saving unit 2100, only those that have not been excluded in step S311 remain, and the calculation is performed in the same manner as in steps S200 and S210. Specifically, the weight w of the AI model is called from the AI model weight saving unit 2200 for the corresponding input, inference is performed at the AI model actual calculation unit 2300 using the AI model on the server, and an inference result q=(q1, q2, . . . , qN) is outputted to the inference result output unit 2400. Subsequently, the loss function calculation unit 2510 calculates the loss function L′ to be used for update of the AI model, using an input q=(q1, q2, . . . , qN) from the inference result output unit 2400 and an input t=(t1, t2, . . . , tN) from the training data saving unit 2520. Upon completion of this process, the output of the calculation progress is performed by transmitting the completion of utilization of the training data from the training data saving unit 2520 to the calculation progress output unit 5000.

Next, in step S410, the loss function calculation unit 2510 performs backpropagation to the calculated loss function and updates the weight of the AI model on the server saved in the AI model weight saving unit 2200.

Further, in step S420, the loss function calculation unit 2510 performs backpropagation to the calculated loss function and calculates an output value ∂L′/∂zi to be used for the update value of the AI model only for the clients that have not been excluded in step S311 or S321, and stores the output value in the server output saving unit 2540.

### <Server Output Process: Step S500>

Finally, in step S500, the server output unit 6000 sends a value stored in the server output saving unit 2540 to the client.

The above description is related to operation during the learning stage. During the evaluation stage, only operation of steps S100 and S200 is performed. The operation during the evaluation stage will be described below.

First, in step S100, input from all clients is received. The input zi (i=1, 2, . . . k) from the clients is received by the server input reception unit 1000 and inputted to the server processing unit 2000. The input from the clients to the server processing unit 2000 is saved in the server input saving unit 2100.

Next, in step S200, the AI model actual calculation unit 2300 performs inference using the AI model on the server. The AI model actual calculation unit 2300 performs a calculation by calling out the weight of the AI model from the AI model weight saving unit 2200 for the input saved in the server input saving unit 2100, and outputs the inference result p=(p1, p2, . . . , pN) to the inference result output unit 2400. After transmitting the inference result to the inference result acquisition unit 3000, the processing of the evaluation stage is completed.

### ***Other Configurations***

In the present embodiment, the function of each device of the machine learning system 500 is implemented by software. As a modification example, the function of each device of the machine learning system 500 can be implemented by hardware.

Specifically, each device of the machine learning system 500 includes an electronic circuit 909 as an alternative to the processor 910.

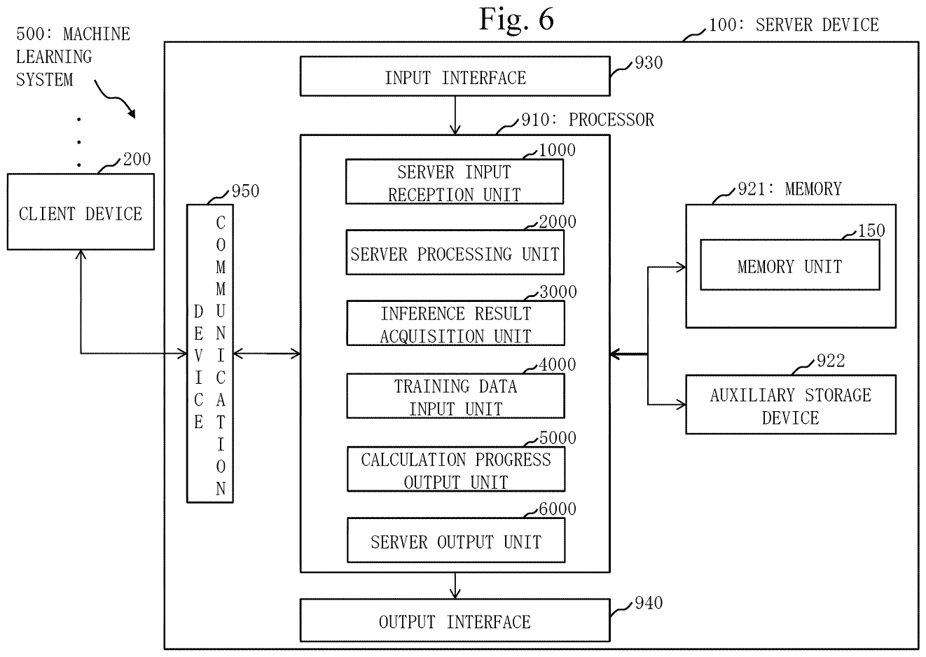

FIG. 6 is a diagram illustrating an example of the configuration of the server device 100 according to the modification example of the present embodiment.

The electronic circuit 909 is a dedicated electronic circuit that implements the functions of the server input reception unit 1000, the server processing unit 2000, the inference result acquisition unit 3000, the training data input unit 4000, the calculation progress output unit 5000, and the server output unit 6000. The electronic circuit 909 specifically is a single circuit, a compound circuit, a programmed processor, a parallel programmed processor, a logic IC, a GA, an ASIC, or an FPGA. GA is an abbreviation for Gate Array. ASIC is an abbreviation for Application Specific Integrated Circuit. FPGA is an abbreviation for Field-Programmable Gate Array.

The functions of the server input reception unit 1000, the server processing unit 2000, the inference result acquisition unit 3000, the training data input unit 4000, the calculation progress output unit 5000, and the server output unit 6000 may be implemented in one electronic circuit, or may be distributed and implemented in a plurality of electronic circuits.

As another modification example, some functions of the server input reception unit 1000, the server processing unit 2000, the inference result acquisition unit 3000, the training data input unit 4000, the calculation progress output unit 5000, and the server output unit 6000 may be implemented by an electronic circuit, and the remaining functions may be implemented by software. Further, some or all functions of the server input reception unit 1000, the server processing unit 2000, the inference result acquisition unit 3000, the training data input unit 4000, the calculation progress output unit 5000, and the server output unit 6000 may be implemented by firmware.

Each of the processor and the electronic circuit is also referred to as processing circuitry. That is, the functions of the server input reception unit 1000, the server processing unit 2000, the inference result acquisition unit 3000, the training data input unit 4000, the calculation progress output unit 5000, and the server output unit 6000 are implemented by the processing circuitry.

### Description of Effects of Embodiment

In the present embodiment, the following machine learning system has been described. The machine learning system may be interpreted as a machine learning device.

In the machine learning device, each of a client that has its own unique learning data and a server that has training data possesses an AI model, and learning proceeds while data remain private to each other. The machine learning device includes a fraudulent client detection unit to estimate or specify a fraudulent client that performs an attack to disrupt the learning of the AI model.

Further, the fraudulent client detection unit is implemented on the server and proceeds with the learning of the entire AI model after estimating or specifying the fraudulent client by comparing the training data with the inference result acquired from the input of the client.

Further, in comparison of the training data with the inference result in the fraudulent client detection unit, estimation or specification of the fraudulent client is performed using contribution to the inference result.

Further, a calculation of the contribution is performed by calculating the similarity between the training data and the inference result, and the contribution among clients that participate in the same server input. When there is inconsistency between the training data and the inference result, a client whose contribution to the incorrect inference result is high is estimated or specified as the fraudulent client, thereby improving the learning efficiency of the AI model. When there is no inconsistency between the training data and the inference result, a client whose contribution to the correct inference result is low is estimated or specified as the fraudulent client, thereby improving the learning efficiency of the AI model.

Further, the machine learning device performs update of the AI model using information of the estimated or specified fraudulent client.

Further, the machine learning device also sends information about the estimated or specified fraudulent client to clients, and more efficient federated learning is promoted by performing model integration among the clients using the information sent to the clients.

In the present embodiment, during vertical federated learning, an attack to disrupt the learning of the AI model by a malicious client is prevented by estimating or specifying the fraudulent client that performs the attack. Vertical federated learning is federated learning that do not share an input neuron to the server among the clients.

As described above, in the machine learning system according to the present embodiment, it is possible to specify a client that has a negative impact on vertical federated learning by calculating the contribution of input of all clients to the training data and comparing the clients transversely. Especially, in defense technologies against horizontal federated learning which is often used as federated learning, it is possible to prevent a decline in the reliability of the AI model by averaging the models uploaded from each client and excluding clients that deviate significantly from this average model. However, in vertical federated learning, the attributes handled by each client are different, and it cannot be said that there is similarity in the information sent from each client to the server. Therefore, defense technologies against a threat of learning disruption attacks on horizontal federated learning cannot be applied to vertical federated learning. In the machine learning system according to the present embodiment, even in a situation where there is no similarity in the information sent from each client to the server, it is possible to estimate or specify malicious and fraudulent clients. Therefore, learning disruption attacks on the server can be prevented.

### Embodiment 2

In the present embodiment, points that differ from Embodiment 1 and points to be added to Embodiment 1 will be mainly described.

In the present embodiment, the same reference signs are used for configurations that have the same functions as those in Embodiment 1, and the description thereof will be omitted.

In the present embodiment, a method of improving the learning efficiency of the AI model will be described.

### ***Description of Configuration***

The configuration of the machine learning system 500 according to the present embodiment is the same as that described in Embodiment 1.

### ***Description of Functions***

In Embodiment 1, when there is inconsistency between the training data and the inference results, the fraudulent client detection unit 2530 determines a client device whose contribution to the incorrect label is high as the fraudulent client device.

In the present embodiment, when there is no inconsistency between the training data and the inference results, the fraudulent client detection unit 2530 treats the inference result as a correct inference result and determines a client device whose contribution to the inference result is low as the fraudulent client device. The correct inference result may be referred to as a correct label or a true label.

### ***Description of Operation***

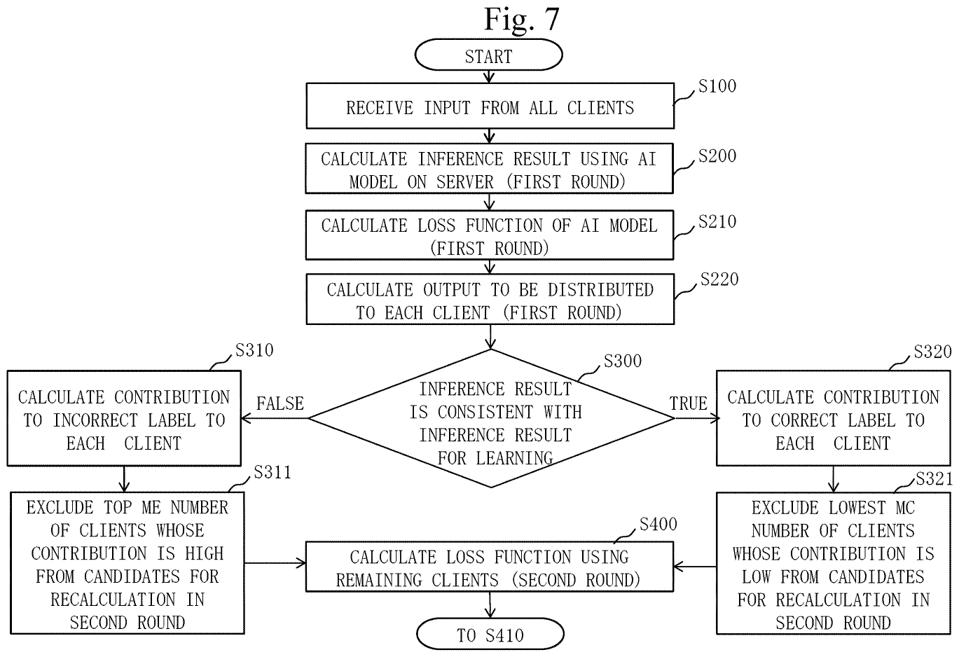

FIG. 7 is a flowchart illustrating the operation of the machine learning system 500 according to the present embodiment.

The process from steps S100 to S400 is described in FIG. 7. The flowchart from step S410 onwards is the same as that in FIG. 5.

In FIG. 7, the processes of steps S320 and S321 are added to the flowchart of FIG. 4 described in Embodiment 1. These processes can exclude a client that transmits fraudulent data, though its impact is small, and a client that participates in valid learning but reduces the learning efficiency. Hence, the learning efficiency of the AI model is improved. The cases that are handled in the present embodiment are the same as those in Embodiment 1. However, compared with Embodiment 1, since the client that transmits fraudulent data, though its impact is small, and the client that participates in valid learning but reduces the learning efficiency are excluded, there is an effect of improving the learning efficiency of the AI model.

The operation will be described below.

As with Embodiment 1, during the learning stage, the calculation of the update value of the AI model is performed twice in steps S220 and S420. The first round consists of steps S200, S210 and S220. Further, the second round consists of steps S400, S410, and S420.

In the present embodiment, since the evaluation stage is the same as that in Embodiment 1, only the learning stage will be described.

The flowcharts during learning illustrated in FIGS. 7 and 5 indicate one iteration of vertical learning, as in Embodiment 1. In the present embodiment, the input of parameters me and a parameter me is required. Values of me and me can be set for each iteration depending on the progress degree of learning or the presence degree of an attacker. The parameter me can be inputted at any timing as long as it is inputted before step S311 in which the parameter me is used withing one iteration. Especially, by deciding the parameter me after calculating the contribution to the incorrect label in step S310, the parameter me can be set as a threshold value for the contribution. Further, the parameter me can also be inputted at any timing as long as it is inputted before step S321 in which the parameter me is used within one iteration. Especially, by deciding the parameter me after calculating the contribution to a correct label in step S320, the parameter me can be set as a threshold value for the contribution. Further, although the flowcharts illustrated in FIGS. 7 and 5 indicate one iteration of vertical federated learning, it is also possible to perform batch processing that handles a plurality of iterations at once.

### <Server Input Reception Process: Step S100>

The process of Step S100 is the same as that in Embodiment 1.

### <Calculation (First Round) of Update Value of AI Model: Steps S200 to S220>

The process from steps S200 to S220 is the same as that in Embodiment 1.

### <Inference Result Consistency Determination Process: Step S300>

In step S300, the fraudulent determination unit 2533 checks whether or not the inference result stored in the inference result output unit 2400 is consistent with the inference result stored in the training data saving unit 2520.

When the inference results are not consistent with each other, that is, when there is inconsistency between the training data and the inference result, it is suspicious that there is a fraudulent client and the process proceeds to step S310.

When the inference results are consistent with each other, that is, there is no inconsistency between the training data and the inference result, the process proceeds to step S320 in order to improve the learning efficiency.

The process for determining whether or not the training data and the inference result are consistent with each other or there is inconsistency between the training data and the inference result in step S300 is the same as that in Embodiment 1. Further, the definition of “consistent” used here is the same as that in Embodiment 1.

### <Contribution Calculation Process (Incorrect Label): Step S310>

### <Fraudulent Client Calculation Process (Incorrect Label): Step S311>

The process from steps S310 to S311 is the same as that in Embodiment 1.

### <Contribution Calculation Process (Correct Label): Step S320>

In step S320, the contribution calculation unit 2531 for each input calculates the contribution of each input for the maximum likelihood inference result of the inference result output unit 2400. Here, the maximum likelihood inference result of the inference result output unit 2400 is denoted as correct label in the flowchart of FIG. 7.

### <Fraudulent Client Calculation Process (Correct Label):Step S321>

Further, from the perspective of learning efficiency, the fraudulent client calculation unit 2532 excludes the lowest me number of clients whose contribution is low to the correct label from candidates for a recalculation of the update value of the AI model in the second round to be described below. Then, the process proceeds to step S400.

### <Calculation of Update Value of AI Model (Second Round): Steps S400 to S420>

In step S400, the loss function calculation unit 2510 recalculates the loss function L′ based on the input values of the remaining clients that have not been excluded in steps S311 and S321. In this calculation, with respect to the input saved in the server input saving unit 2100, only those that have not been excluded in steps S311 and S321 remain, and the calculation is performed in the same manner as in steps S200 and S210.

The process of step S400 differs from that in Embodiment 1 in that it only retains the inputs that have not been excluded in steps S311 and S321. The rest of the process is the same as that in Embodiment 1.

Further, the process from steps 410 to S420 is also the same as that in Embodiment 1.

### <Server Output Process: Step S500>

The process of step S500 is the same as that in Embodiment 1.

### Description of Effects of Embodiment

As described above, in the machine learning system according to the present embodiment, the contribution of input of all clients to the training data is calculated in steps S310 and S311, and the clients are compared transversely. As a result, it is possible to specify a client that has a negative impact on vertical federated learning. Further, in steps S320 and S321, it is possible to exclude a client that transmits fraudulent data, though its impact is small, and a client that participates in valid learning but reduces the learning efficiency. Hence, it is possible to further improve the learning efficiency of the AI model.

### Embodiment 3

In the present embodiment, points that differ from Embodiments 1 and 2 and points to be added to Embodiments 1 and 2 will be mainly described.

In the present embodiment, the same reference signs are used for configurations that have the same functions as those in Embodiments 1 and 2, and the description thereof will be omitted.

In the present embodiment, the machine learning system 500 is assumed to perform non-interactive split federated learning among the plurality of client devices 200.

In the present embodiment, a method will be described in which the machine learning method described in Embodiments 1 and 2 is applied not only to vertical federated learning, but also to split federated learning which is a broader federated learning technique that includes vertical federated learning.

Split federated learning is federated learning that has a characteristic that each of the clients and the server possesses its own AI model, and an output inference result is sorely possessed by the server. Split federated learning can be applied not only to vertical federated learning described in Embodiments 1 and 2, but also to horizontal federated learning.

The structure of general split federated learning will be defined.

First, the server and each client have their own AI model, and the inference result is outputted by the AI model of the server. This inference result is sorely possessed by the server. When each client performs inference, input to the server is performed. At this time, it is assumed that a portion of the predetermined neurons in an input unit of the server is used. The neurons used by each client may overlap. When there is no overlap in the neurons used by each client, the vertical federation learning of Embodiments 1 and 2 is corresponded. Further, in addition to the communication between the server and the clients, sharing of AI models among the clients may occur. However, the sharing of AI models among the clients includes the sharing of entire AI models as well as the sharing of partial AI models. In vertical federated learning, since the AI models of the clients are completely split, a calculation related to this sharing is not considered. In the present embodiment, a technique to prevent learning disruption attacks against such split federated learning will be proposed.

In the present embodiment, the same specific examples as those in Embodiment 1 can be treated. Further, more generally, it is possible to apply federated learning more flexibly in such a case where the scope of data to be collected by a participating institution is not defined. The present embodiment can also be applied to the machine learning system that is applied to FA equipment, for example.

The server processing unit 2000 is a computer such as a host computer installed in a mother factory. The client is, for example, a computer installed in a contracted manufacturing factory. In the present embodiment, when a single product is manufactured, each contracted manufacturing factory is in charge of a part of the process. Factories are not one-to-one corresponding to each process, and a plurality of factories are switched for an optimal production plan. However, for technology protection purposes, the contracted manufacturing factory keeps its process, the equipment used in the process, and the equipment data in the process confidential to the mother factory or other contracted manufacturing factories.

Here, it is considered to integrate information of each factory for performing automation and refinement of inspection. In the present embodiment, each contracted manufacturing factory transmits data obtained by each equipment to the host computer installed in the mother factory after manipulating the data by the AI model. Subsequently, the host computer installed in the mother factory performs the inspection. Especially, unlike the vertical federated learning of Embodiment 1, even if the factory in charge of each process changes, the efficient and precise inspection is possible in the present embodiment. Further, integrating AI models among the factories in charge of each process can result in the construction of a more accurate AI model. As for this inspection system, an attack method is considered in which a malicious client manipulates the input data during learning to modify the AI model, for example. This is considered to be done for an attempt such as to hide fraud by the malicious client, even in the absence of producing a component that meets specifications. In this case, in the present embodiment, it is possible to specify or estimate the malicious client that transmits manipulated input data and protect the AI model on the server from an attack such as the above.

In the present embodiment, the same extension is possible in other specific examples mentioned in Embodiment 1, such as determination on health screenings and personal credit information. First, in the health screenings, even if a person being examined regularly visits a different hospital, diagnosis is possible based on the same principles as described above. Further, in the case of the determination on personal credit information, there are cases where customers change the stores they use, and the data collection agency may change. Even in this case, the determination of credit information is possible. In the present embodiment, it is possible to take measures against learning disruption attacks on the AI model even under circumstances described such as the above.

Therefore, in the present embodiment, addition of fraudulent client information to the output value of the server and responses of the clients based on the additional information can improve not only the learning efficiency of the AI model of the server, but also the learning efficiency of the AI models of the clients.

### ***Configuration and Operation of Server Device 100***

Details of the present embodiment will be described in the following. First, the server will be described.

In the present embodiment, as with Embodiments 1 and 2, input values of clients that have the same inference results are collected, and their contributions are calculated. In the present embodiment, the configuration of the server device 100 is the same as that of the diagram of the functional configuration in FIG. 3. Further, the operation of the server device 100 is the same as that of the flowcharts in FIGS. 4 and 5 or FIG. 7.

In the present embodiment, information sent from the server to the clients and operation on the clients are determined according to a specific embodiment among the server and the clients. As a result, in the present embodiment, it is possible to apply the machine learning method described in Embodiments 1 and 2 to split federated learning.

Operation of the server will be described in the following. Especially, the generation origin of differences from Embodiments 1 and 2 will be described. Specifically, steps S310, S320, and S500 in the flowcharts of FIGS. 4 and 5 or FIG. 7 will be described.

Especially, in the present embodiment, it is assumed that a plurality of inputs are made for the same training data, and learning of the AI model is performed. This assumption is a reasonable assumption in machine learning that handles a large amount of data to learn.

Further, in the present embodiment, as with Embodiments 1 and 2, inputs of parameters me and me are required.

Setting of values for the parameters me and mc, input timings of the parameters me and mc, and setting the parameters me and me as threshold values are the same as those in Embodiments 1 and 2.

First, steps S310 and S320, that is, differences in the contribution calculation for the inference results will be described. In Embodiments 1 and 2, the contribution of each client is evaluated transversely for a single inference result. However, in the present embodiment, there is also a possibility that the clients provide the entire input value of the server. In this case, it is not possible to properly perform a transversal evaluation of the contribution of each client. Therefore, in the present embodiment, a plurality of same inference results are collected, and the calculation of contribution of each client is performed. In the following, an example of the calculation of contribution is indicated.

Step S310 will be described in the following. A purpose of step S310 is to establish a ranking of contributions to the incorrect label. Therefore, first, by the similarity between the training data and the inference result, it is determined that, by assigning a rank to a set of clients, the contribution of the clients that participate in the server input for which the training data and inference result are similar is great. At this point, the clients that participate in the same server input are ranked equally. Subsequently, among the clients that participate in the same server input, the rank is given according to the contribution to the training data. At this time, it is assumed that the relation of the rank with other server inputs will be maintained. As described above, it is possible to decide a rank of contributions to the incorrect label. Also, in the same manner for step S320, it is possible to decide a rank of contributions to the correct label.

Next, step S500, that is, differences in gradient distribution to each client will be described. In the present embodiment, by sharing the AI model among the clients, the AI model may be updated. At this time, integrating the model of the client that performs a learning disruption attack into other clients leads to promotion of a further learning interference attack. Therefore, in the present embodiment, during the gradient distribution to each client, the server transmits to the clients, a number of a client that has determined as a valid client to prevent learning disruption attacks by the model sharing among the clients. Specifically, in addition to the value ∂L/∂zi to be used for update of the AI model of the client, the server transmits to the clients simultaneously, a set B={2, 5, 6, . . . , N−1} which is a set of numbers of valid clients. Further, the client itself may transmit trust degree information of each client in order to perform control according to its circumstances.

The above is the description related to the server.

### ***Configuration and Operation of Client Device 200***

Next, the description related to the client will be given. In the present embodiment, the client needs to operate in accordance with the behavior of the server.

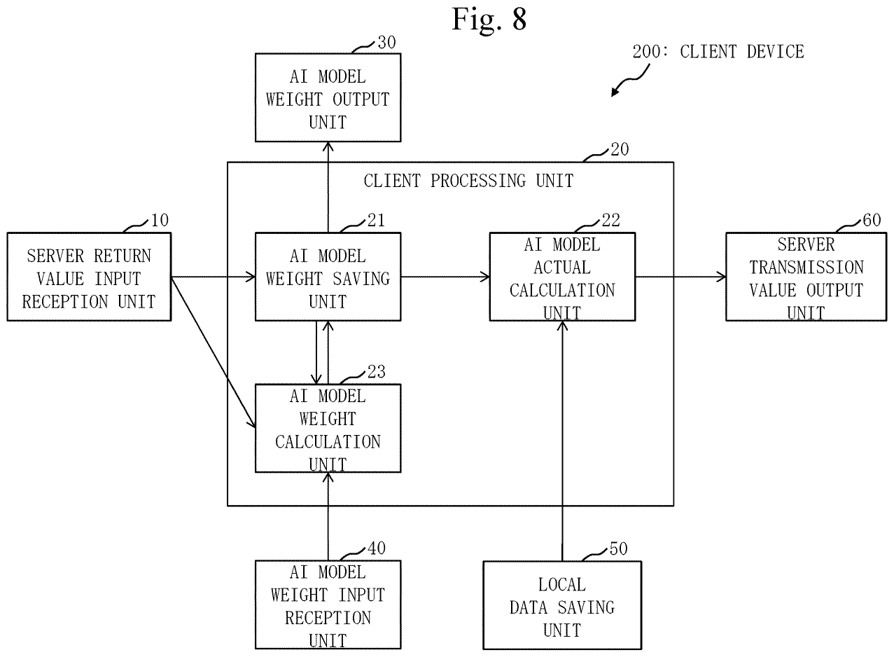

FIG. 8 is a diagram illustrating an example of a functional configuration of the client device 200 according to the present embodiment.

The client of the present embodiment refers to the client device 200 that performs regular processing. The client device that performs a learning disruption attack may not be in accordance with the description below in order to establish the attack.

The client device 200 according to the present embodiment includes, as functional elements, a server return value input reception unit 10, a client processing unit 20, an AI model weight output unit 30, an AI model weight input reception unit 40, a local data saving unit 50, and a server transmission value output unit 60. The AI model weight output unit 30 is also referred to as an AI model weight output unit of another client. The AI model weight input reception unit 40 is also referred to as an AI model weight input reception unit of another client.

The hardware configuration of the client device 200 according to the present embodiment is the same as that of the server device 100 as described in Embodiment 1.

The server return value input reception unit 10 inputs a server return value that includes AI model update information from the server. The server return value input reception unit 10 outputs to the AI model weight saving unit 21 and the AI model weight calculation unit 23, the server return value that includes AI model update information from the server.

The client processing unit 20 inputs the AI model update information on the client from the server return value input reception unit 10, and updates the weight of the AI model internally. Further, the client processing unit 20 outputs its own AI model weight to the AI model weight output unit 30 of the other client for the purpose of integration of AI models with other clients. Further, the client processing unit 20 updates the AI model by inputting the AI weight of the other client from the AI model weight input reception unit 40 of the other client. Further, the client processing unit 20 performs inference by the AI model of the client using local saved data inputted from the local data saving unit 50, and outputs to the server transmission value output unit 60, an output value to the server.

Details of the client processing unit 20 will be described in the following.

The client processing unit 20 includes an AI model weight saving unit 21, an AI model actual calculation unit 22, and an AI model weight calculation unit 23.

The AI model weight saving unit 21 outputs the weight of the AI model at a certain point to the AI model weight calculation unit 23, and inputs the updated weight of the updated AI model from the AI model weight calculation unit 23. Further, according to a value inputted from the server return value input reception unit 10, the AI model weight saving unit 21 outputs the AI model to the AI model weight output unit 30 of the other client in order to share the weight of the AI model with the other client. Further, the AI model weight saving unit 21 outputs the weight of the AI model to the AI model actual calculation unit 22 in order to update the weight of the next AI model during the learning stage, or to perform inference during the evaluation stage.

The AI model actual calculation unit 22 inputs the weight of the AI model from the AI model weight saving unit 21 and data from the local data saving unit 50, performs inference using the AI model of the client, and outputs to the server transmission value output unit 60, an output value to be transmitted to the server.

The AI model weight calculation unit 23 calculates the weight of the updated AI model based on the update value of the AI model inputted from the server return value input reception unit 10 and the weight of the AI model at a certain point inputted from the AI model weight saving unit 21. The AI model weight calculation unit 23 outputs the weight of the updated AI model to the AI model weight saving unit 21.

Further, the AI model weight calculation unit 23 calculates the weight of the updated AI model and outputs the weight of the updated AI model to the AI model weight saving unit 21. At this time, the AI model weight calculation unit 23 calculates the weight of the updated AI model using the following information.
Information of regular clients inputted from the server return value input reception unit 10
The weight of the AI model at a certain point inputted from the AI model weight saving unit 21
Input AI weight from the other client in the AI model weight input reception unit 40 of the other client

The AI model weight output unit 30 of the other client outputs to other clients, the weight of the AI model inputted from the AI model weight saving unit 21.

The AI model weight input reception unit 40 of the other client inputs the AI models from other clients and outputs the AI model to the AI model weight calculation unit 23.

The local data saving unit 50 inputs and saves local data individually possessed by each client and outputs the local data to the AI model actual calculation unit 22.

The server transmission value output unit 60 outputs to the server, a transmission value to the server inputted from the AI model actual calculation unit 22.

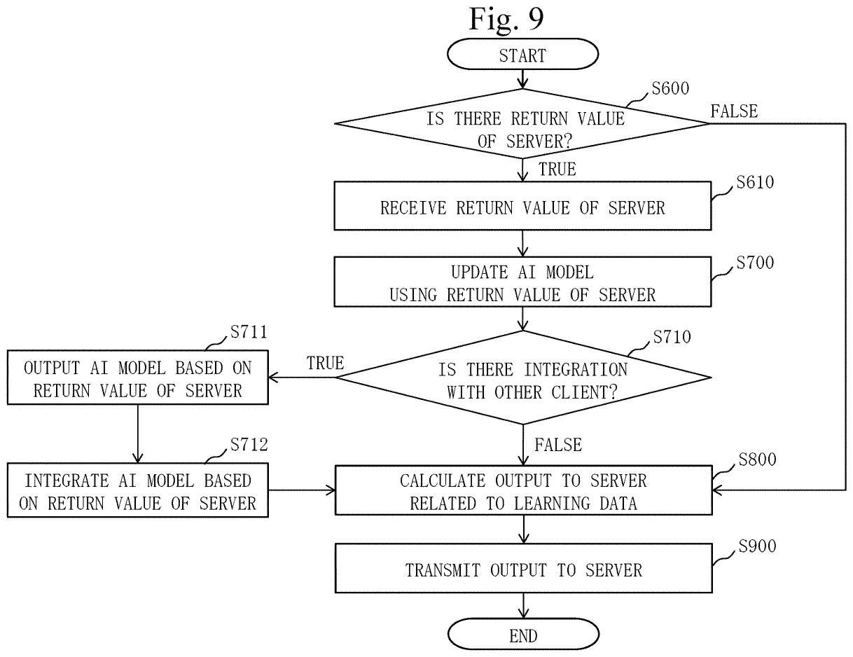

FIG. 9 is a flowchart illustrating operation of the client device 200 in the machine learning system 500 according to the present embodiment.

The operation of the client will be described in the following. Machine learning including federated learning consists of two stages: the learning stage for updating the AI model; and the evaluation stage for utilizing the AI model that has completed learning. The present embodiment mainly handles the learning stage.

First, the flow of the operation of the learning stage for updating the AI model will be described.

First, in step S600, the server return value input reception unit 10 checks whether or not there is a server return value which is a return value from the server. Specifically, at the start of learning, it is assumed that there is no server return value. In this case, the process proceeds to step S800. When there is the server return value, the process proceeds to step S610.

In step S610, the server return value input reception unit 10 receives the server return value.

Next, in step S700, the AI model weight calculation unit 23 updates the AI model saved in the AI model weight saving unit 21 using the server return value that has been received by the server return value input reception unit 10.

In step S710, the AI model weight calculation unit 23 determines whether or not there is integration of AI models with other clients. When there is the integration of AI models with other models, the process proceeds to step S711. When not, the process proceeds to step S800.

In step S711, the AI model weight output unit 30 transmits its own AI model to a specified other client. Specifically, the AI model weight output unit 30 transmits its own AI model to the specified other client using information about a trustworthy client included in the server return value. In step S711, a method is considered in which the AI model is transmitted to the number specified by the server, or a transmission destination of the AI model is decided on the client side according to the reliability received from the server.

In step S712, the AI model weight calculation unit 23 updates the AI model saved in the AI model weight saving unit 21 based on the server return value. Specifically, the AI model weight calculation unit 23 receives the AI model from the other client received by the AI model weight input reception unit 40 and updates the AI model using the information about the trustworthy client included in the server return value. In step S712, a method is considered in which the AI model whose number is specified by the server is integrated, or the AI model is integrated by unique weighting on the client side according to the reliability received from the server.

In step S800, the AI model actual calculation unit 22 calculates output using the local data called from the local data saving unit 50 and the AI model saved in the AI model weight saving unit 21.

Finally, in step S900, the output calculated by the AI model actual calculation unit 22 is transmitted to the server by the server transmission value output unit 60.

The above is the description related to the operation during the learning stage. During the evaluation stage, only the processes of steps S800 and S900 are performed. The operation during the evaluation stage will be described in the following.

First, in step S800, the AI model actual calculation unit 22 calculates output using the local data called from the local data saving unit 50 and the AI model saved in the AI model weight saving unit 21.

Subsequently, in step S900, the output calculated by the AI model actual calculation unit 22 is transmitted to the server by the server transmission value output unit 60.

### Description of Effects of Embodiment

The machine learning system according to the present embodiment is applied to non-interactive split federated learning among the clients. It is possible to prevent learning disruption attacks by the fraudulent client detection unit to estimate or specify a fraudulent client that performs an attack that disrupts learning of the AI model.

As described above, in the present embodiment, split federated learning is generally defined. In the present embodiment, addition of fraudulent client information to the output value of the server and responses of the clients based on the additional information can improve not only the learning efficiency of the AI model of the server, but also the learning efficiency of the AI models of the clients.

The machine learning system according to Embodiments 1 to 3 can be applied to, for example, federated learning based on subtle information such as diagnose in the medical field or determination of credit information in the financial field. Specifically, the machine learning system according to Embodiments 1 to 3 is capable of limiting the disclosure range of subtle information while maintaining the performance of the device. As a result, it is possible to construct a more precise machine learning system.

Further, the machine learning system according to Embodiments 1 to 3 can be applied to, for example, various systems such as FA, a security management system, and an autonomous mobile robot. Specifically, the machine learning system according to the present disclosure is suitable for use with AI for industrial robots.

In Embodiments 1 to 3 described above, each unit of each device of the machine learning system has been described as an independent function block. However, the configuration of the machine learning system may be different from the configuration in the embodiments described above. The function blocks of the machine learning system may be configured in any manner as long as they can implement the functions described in the embodiments described above. The machine learning system may be a system configured with a plurality of devices instead of a single device.

Further, any combination of a plurality of portions from Embodiments 1 to 3 can be implemented. Alternatively, one portion of these embodiments may be implemented. These embodiments may be implemented as a whole or partially in any other combination.

In other words, in Embodiments 1 to 3, a free combination of each embodiment, a modification example of any component of each embodiment, or omission of any component in each embodiment is possible.

The embodiments described above are essentially preferred examples and are not intended to limit the scope of the present disclosure, the range of applications of the present disclosure, and the range of uses of the present disclosure. The embodiments described above can be modified as needed in various manners. The procedures described using the flowcharts or the sequence diagrams may be modified appropriately, for example.

### REFERENCE SIGNS LIST

10: server return value input reception unit; 20: client processing unit; 30: AI model weight output unit; 40: AI model weight input reception unit; 50: local data saving unit; 60: server transmission value output unit; 21: AI model weight saving unit; 22: AI model actual calculation unit; 23: AI model weight calculation unit; 100: server device; 150: memory unit; 200: client device; 500: machine learning system; 1000: server input reception unit; 2000: server processing unit; 3000: inference result acquisition unit; 4000: training data input unit; 5000: calculation progress output unit; 6000: server output unit; 2100: server input saving unit; 2200: AI model weight saving unit; 2300: AI model actual calculation unit; 2400: inference result output unit; 2500: learning device unit; 2510: loss function calculation unit; 2520: training data saving unit; 2530: fraudulent client detection unit; 2540: server output saving unit; 2531: contribution calculation unit; 2532: fraudulent client calculation unit; 2533: fraudulent determination unit; 909: electronic circuit; 910: processor; 921: memory; 922: auxiliary storage device; 930: input interface; 940: output interface; 950: communication device.

1. A machine learning system comprising a client device that has its own unique learning data and a server device that has training data, each of the client device and the server device possessing an Artificial Intelligence (AI) model, and proceeding with learning while keeping the learning data of the client device and the training data of the server device private to each other, wherein
the server device comprises processing circuitry to estimate a fraudulent client device that performs an attack that disrupts the learning of the AI model in the server device, and
to estimate the fraudulent client device by comparing the training data with an inference result acquired from input of the client device.

2. The machine learning system according to claim 1, wherein
the processing circuitry, when comparing the training data with the inference result, calculates contribution to the inference result in the client device and estimates the fraudulent client device using the contribution to the inference result.

3. The machine learning system according to claim 2, wherein
the processing circuitry calculates similarity between the training data and the inference result, determines whether or not there is inconsistency between the training data and the inference result based on the similarity, and when there is the inconsistency between the training data and the inference result, treats the inference result as an incorrect inference result and estimates a client device whose contribution to the inference result is high as the fraudulent client device.

4. The machine learning system according to claim 3, wherein,
the processing circuitry, when there is no inconsistency between the training data and the inference result, treats the inference result as a correct inference result and estimates a client device whose contribution to the inference result is low as the fraudulent client device.

5. The machine learning system according to claim 1, wherein,
the processing circuitry performs update of the AI model in the server device using information of the fraudulent client device.

6. The machine learning system according to claim 1, wherein,
the processing circuitry outputs the information of the fraudulent client device to the client device, and
the client device performs integration of AI models among other client devices based on the information of the fraudulent client device.

7. The machine learning system according to claim 1 comprising
a plurality of client devices each of which has its own unique learning data, as the client devices, each of the plurality of client devices and the server device possessing an AI model, and performing non-interactive split federated learning among the plurality of client devices.

8. The machine learning system according to claim 1 comprising
a plurality of client devices each of which has its own unique learning data, as the client devices, each of the plurality of client devices and the server device possessing an AI model, and performing vertical federated learning that does not share an input neuron to the server device among the plurality of client devices.

9. A machine learning system comprising a client device that has its own unique learning data and a server device that has training data, each of the client device and the server device possessing an Artificial Intelligence (AI) model, and proceeding with learning while keeping the learning data of the client device and the training data of the server device private to each other, wherein
the server device comprises processing circuitry to estimate a fraudulent client device that performs an attack that disrupts the learning of the AI model in the server device, and
to output the information of the fraudulent client device to the client device, and
the client device performs integration of AI models among other client devices based on the information of the fraudulent client device.

10. A server device included in a machine learning system comprising a client device that has its own unique learning data and a server device that has training data, each of the client device and the server device possessing an Artificial Intelligence (AI) model, and proceeding with learning while keeping the learning data of the client device and the training data of the server device private to each other, wherein
the server device comprises processing circuitry to estimate a fraudulent client device that performs an attack that disrupts the learning of the AI model in the server device and
to estimate the fraudulent client device by comparing the training data with an inference result acquired from input of the client device.

11. A client device included in a machine learning system comprising a client device that has its own unique learning data and a server device that has training data, each of the client device and the server device possessing an Artificial Intelligence (AI) model, and proceeding with learning while keeping the learning data of the client device and the training data of the server device private to each other, wherein
the client device estimates a fraudulent client device that performs an attack that disrupts the learning of the AI model in the server device, acquires information of the fraudulent client device from the server device that outputs the information of the fraudulent client device obtained through estimation, and performs integration of AI models among other client devices based on the information of the fraudulent client device.

12. A machine learning method used in a machine learning system comprising a client device that has its own unique learning data and a server device that has training data, each of the client device and the server device possessing an Artificial Intelligence (AI) model, and proceeding with learning while keeping the learning data of the client device and the training data of the server device private to each other, wherein
the server device estimates a fraudulent client device that performs an attack that disrupts the learning of the AI model in the server device by comparing the training data with an inference result acquired from input of the client device.

13. A non-transitory computer readable medium storing a machine learning program used in a machine learning system comprising a client device that has its own unique learning data and a server device that has training data, each of the client device and the server device possessing an Artificial Intelligence (AI) model, and proceeding with learning while keeping the learning data of the client device and the training data of the server device private to each other, wherein
the machine learning program for causing a computer to execute a fraudulent client detection process to estimate a fraudulent client device that performs an attack that disrupts the learning of the AI model in the server device by comparing the training data with an inference result acquired from input of the client device.
